(19) United States
(12) Patent Application Publication
(10) Pub. No.: US 2024/0134972 A1
(43) Pub. Date: Apr. 25, 2024

(54) OPTIMIZING INTELLIGENT THRESHOLD ENGINES IN MACHINE LEARNING OPERATIONS SYSTEMS

(71) Applicant: Microsoft Technology Licensing, LLC, Redmond, WA (US)

(72) Inventors: Laurent BOUE, Peteh Tikva (IL); Kiran RAMA, Bangalore (IN)

(21) Appl. No.: 18/046,489

(22) Filed: Oct. 13, 2022

(51) Int. Cl. G06F 21/55

(52) U.S. Cl. CPC G06F 21/554; G06F 2221/034

(57) ABSTRACT

A sample of data, including a risk factor, is selected by a machine learning (ML) model of an extreme value theory (EVT) mechanism. A threshold is determined by the ML model based on the risk factor, an outlier score is generated for the sample, and the outlier score is compared to the threshold. The sample is identified as anomalous based on the generated outlier score being greater than the threshold. A schema comprising results of an investigation into the sample and the risk factor is updated based on the received schema.

### BACKGROUND

Engineering systems, including virtual storage, virtual networking, network streaming, Internet of Things (IoT) devices, software as a service (SaaS), and so forth, are composed of several components including data sensors, machine learning (ML) models, and so forth, that continuously produce numerous data and metrics that are used to monitor the overall health of the system. When one or more of the components produce data that falls outside of a predetermined range, the potential anomaly is investigated to confirm the anomaly or determine the data is not an anomaly. ML models within machine learning operation systems (MLOps systems) use thresholds that are used to identify potential anomalies to be investigated. These thresholds are typically based on heuristics or statistical measures of distance from central tendency measures.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and implementations disclosed herein are directed to systems and methods that use extreme value theory (EVT) to optimize an intelligent threshold in a ML model. For example, the method includes selecting, by a machine learning (ML) model of an extreme value theory (EVT) mechanism, a sample of data from a dataset, the sample including a risk factor, determining, by the ML model, a threshold for the sample based at least in part on the risk factor, generating, by a score generator, an outlier score for the sample, comparing, by an anomaly identifier, the generated outlier score to the determined threshold, identifying, by the anomaly identifier, the sample as anomalous based on the generated outlier score being greater than the threshold, receiving, by the ML model, a schema comprising results of an investigation into the sample, and updating, by the ML model, the risk factor based on the received schema.

### BRIEF DESCRIPTION OF THE DRAWINGS

The present description will be better understood from the following detailed description read in light of the accompanying drawings, wherein:

FIG. 1 is a block diagram illustrating an example computing device for implementing various examples of the present disclosure;

FIG. 2 is a block diagram illustrating an example system for implementing various examples of the present disclosure;

FIG. 3 is a flowchart illustrating a computer-implemented method of determining whether a sample is anomalous according to various examples of the present disclosure;

FIG. 4 is a flow chart illustrating a computer-implemented method of optimizing an intelligent threshold in a machine learning (ML) model according to various examples of the present disclosure;

FIG. 5 is a flow chart illustrating a computer-implemented method of optimizing an intelligent threshold in a ML model according to various examples of the present disclosure; and

FIG. 6 is a flow chart illustrating a computer-implemented method of optimizing an intelligent threshold in a ML model according to various examples of the present disclosure.

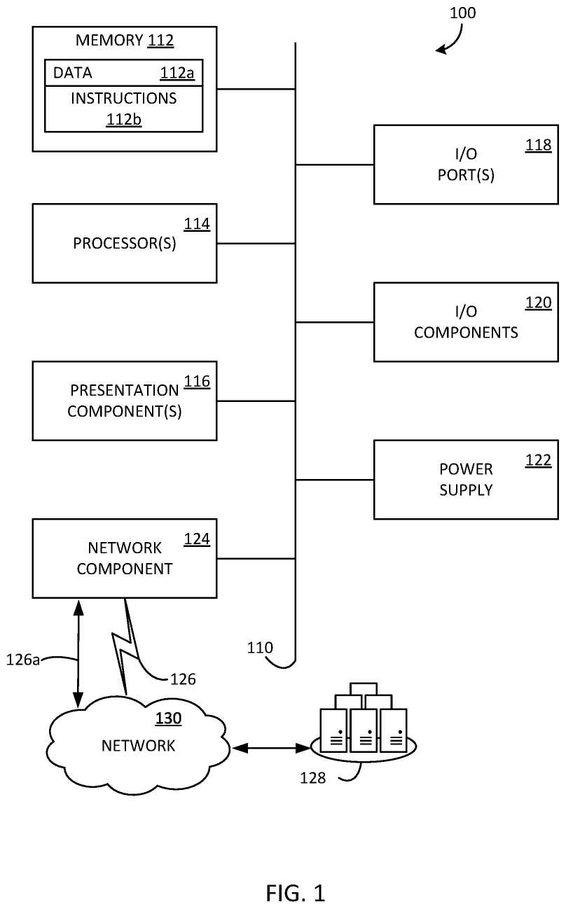

Corresponding reference characters indicate corresponding parts throughout the drawings. In FIGS. 1 to 6, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Engineering systems are composed of multiple components, including data sensors, ML models, and so forth that continuously produce, or receive, numerous metrics based on the particular system. For example, a virtual storage system generates metrics related to throughput, bandwidth, writes per second, latency, and so forth of the physical hard drives that form a part of the virtual storage system. As another example, an IoT device outputs information regarding an on/off state of edge devices, the gateways, and other information specific to the edge devices. Due to the overwhelming quantity of the metrics and the fact that these metrics are often generated and analyzed in real-time, methods of identifying anomalies in the metrics are complex but essential.

Current methods of detecting anomalies include the comparison of data and metrics to thresholds that, when exceeded, indicates a potential anomaly in the data. However, conventional solutions utilize thresholds that are based on heuristics or statistical measures of distance from central tendency measures.

Current solutions, upon detection of a potential anomaly, send an alert to an internal response team (IRT), whose role is to investigate the detected potential anomaly. The investigation may be performed manually, by an individual identifying and reviewing the sample in which the potential anomaly was detected to determine whether the sample is truly an anomaly or not. In other instances, the investigation is performed using a machine learning operation system (MLOps system) to perform the investigation more quickly and efficiently. However, current iterations of the ML models are not robust enough to sufficiently identify anomalies due to a lack of suitable training data and/or a lack of ability to effectively identify and predict thresholds for anomalous samples. For example, an IRT is unable to review each anomaly score in instances where the threshold is set conservatively, because an overwhelming number of potential anomalies are returned, while a threshold that is set too aggressively will result in actual anomalies not being returned.

Accordingly, examples of the present disclosure provide systems and methods for an improved ML model that generates an intelligent threshold for identifying anomalous data samples. The ML model implements EVT, as described herein, and is trained using a more robust, diverse training data set. By implementing a more robust training data set, the ML model more accurately determines the threshold for anomalous samples of a particular dataset. As additional datasets are analyzed by the ML model, a feedback loop is created that properly interprets risk factors, which in turn enables probabilities and anomalous samples to be identified quickly, accurately, and with reduced or eliminated human intervention.

Upon detection of the potential anomaly in the dataset, the potential anomaly is labeled with a first label and an investigation into the anomaly is triggered. Upon conclusion of the investigation, the potential anomaly is returned to the ML model with a second label. Where the first label and the second label match, the ML model receives confirmation, i.e., positive feedback, of the correct identification of the anomaly. Where the first label and the second label do not match, the ML model receives negative feedback and adjusts at least one risk factor in order to more precisely identify future potential anomalies.

Upon confirmation of the anomaly in the dataset, an action may be triggered. The specific action is dependent upon various factors, including the engineering system executing the systems and methods. For example, an engineering system for one or more IoT devices that detects an anomaly in an IoT device may indicate that a particular device has failed or is susceptible to failing. The triggered action for this scenario may be to repair or replace the failed device. In another example, an engineering system that performs virtual computing for a payment system may detect an anomaly indicating an order of an unusual size or from an unusual account. The triggered action for this scenario may be to flag the order as potentially fraudulent and either decline to process the order or investigate the order prior to fulfillment. However, these examples are presented for illustration only and should not be construed as limiting. The systems and methods presented herein may be executed by any type of engineering system triggering a particular action without departing from the scope of the present disclosure.

As referenced herein, EVT refers to a branch of mathematics that focuses on the statistics of extreme events, such as the behavior of the maximum and/or minimum, of random variables. Given a defined risk factor q, the EVT may be leveraged to extract a threshold z such that the probability of any sample s to exceed the threshold z is guaranteed to be less than the desired risk factor q. The threshold z can be extracted by applying the Pickands-Balkema-de Haan theorem using the peak over threshold (POT) technique to predict thresholds associated with risk factors so small that otherwise are difficult or impossible to estimate empirically, because their likelihood is such that they may have never been observed.

Aspects of the present disclosure provide numerous technical solutions that improve the functioning of the computing device that executes the ML model. For example, the implementation of EVT into the anomaly detector that executes the ML model enables risk factors to be expressed as a mathematical probability, rather than an arbitrary score that cannot be directly interpreted as a probability. The ML model is continually updated and improved due to the feedback loop present between the ML model and the investigator, which produces feedback regarding potential anomalies identified, in order to intelligently optimize the threshold for anomalous samples. For example, risk factors and an initial calibration sample of data may be adjusted based on the feedback received from the investigator, which intelligently optimizes the threshold for anomalous samples while maintaining low latency and real-time requirements of the computing device.

FIG. 1 is a block diagram illustrating an example computing device 100 for implementing aspects disclosed herein and is designated generally as computing device 100. Computing device 100 is but one example of a suitable computing environment and is not intended to suggest any limitation as to the scope of use or functionality of the examples disclosed herein. Neither should the computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Program components include routines, programs, objects, components, data structures, and the like that refer to code, performs particular tasks, or implement particular abstract data types. The disclosed examples may be practiced in a variety of system configurations, including servers, personal computers, laptops, smart phones, servers, virtual machines (VMs), mobile tablets, hand-held devices, consumer electronics, specialty computing devices, etc. The disclosed examples may also be practiced in distributed computing environments when tasks are performed by remote-processing devices that are linked through a communications network.

The computing device 100 includes a bus 110 that directly or indirectly couples the following devices: computer-storage memory 112, one or more processors 114, one or more presentation components 116, I/O ports 118, I/O components 120, a power supply 122, and a network component 124. While the computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an operating system (OS), a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor 114, by multiple processors 114 within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Example presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN); metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

As described herein, the computing device 100 may be implemented as one or more servers. The computing device 100 may be implemented as a system 200 or in the system 200 as described in greater detail below.

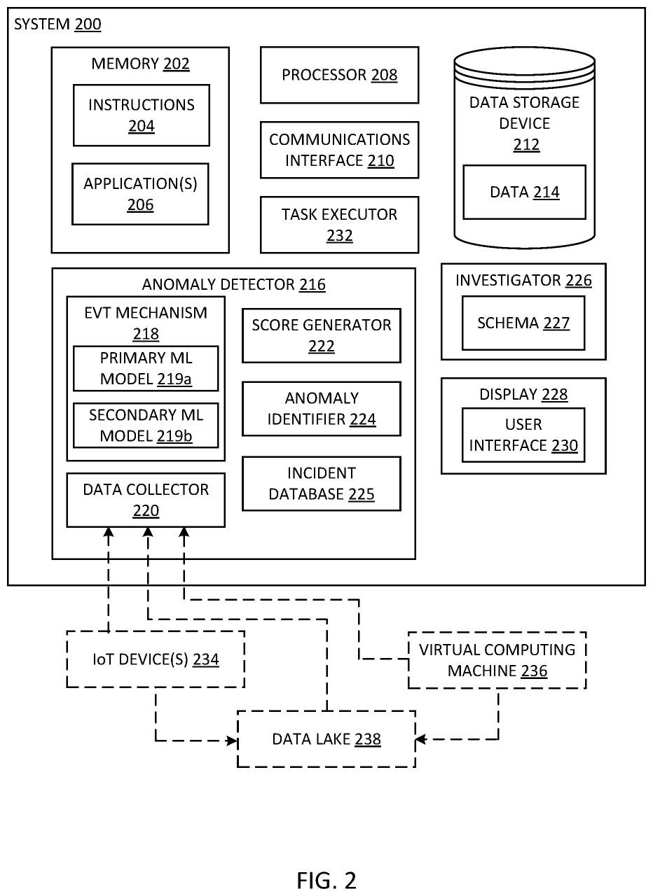

FIG. 2 is a block diagram illustrating an example system for implementing various examples of the present disclosure. The system 200 may include the computing device 100. In some implementations, the system 200 includes a cloud-implemented server that includes each of the components of the system 200 described herein. In some implementations, the system 200 is presented as a single computing device that contains each of the components of the system 200. In other implementations, the system 200 includes multiple devices.

The system 200 includes a memory 202, a processor 208, a communications interface 210, a data storage device 212, an anomaly detector 216, an investigator 226, a task executor 232, and a user interface 230. The memory 202 stores instructions 204 executed by the processor 208 to control the communications interface 210, the anomaly detector 216, the investigator 226, the user interface 230, and the task executor 232. The memory 202 further stores data, such as one or more applications 206. An application 206 is a program designed to carry out a specific task on the system 200. For example, the applications 206 may include, but are not limited to, virtual computing applications, IoT device management applications, payment processing applications, drawing applications, paint applications, web browser applications, messaging applications, navigation/mapping applications, word processing applications, gaming applications, video applications, an application store, applications included in a suite of productivity applications such as calendar applications, instant messaging applications, document storage applications, video and/or audio call applications, and so forth, and specialized applications for a particular system 200. The applications 206 may communicate with counterpart applications or services, such as web services.

The processor 208 executes the instructions 204 stored on the memory 202 to perform various functions of the system 200. For example, the processor 208 controls the communications interface 210 to transmit and receive various signals and data, controls the data storage device 212 to store data 214, controls the anomaly detector 216 to detect anomalies in received data or data collected by the system 200, and controls the user interface 230.

The data storage device 212 stores data 214. The data 214 may include any data, including data collected by a data collector 220 implemented on the anomaly detector 216. In some examples, the data 214 is input data comprising a number of samples, n. The input data 214 may be defined as S={s_1, s_2, . . . , s_n}. Each feature of data, s, comprises a number of features, k. which is expressed as s_i={f_1, f_2, . . . , f_k}. In some examples, the data 214 is data captured by an IoT device 234 or a virtual computing machine 236 that is collected directly by the data collector 220 for analysis. In some examples, the data 214 is data captured by an IoT device 234 or a virtual computing machine 236 that is aggregated into a data lake 238 and then obtained, or imported, by the data collector 220 for analysis.

The anomaly detector 216 is implemented on the processor 208 and includes an EVT mechanism 218, the data collector 220, a score generator 222, and an anomaly identifier 224. The EVT mechanism 218 is a specialized processing unit that executes a primary machine learning (ML) model 219a or algorithm to perform one or more calculations described herein to calculate a probability value, calculate a threshold, and assign an outlier score based on the calculated probability value and threshold. The probability value and threshold are calculated for a sample of data 214 collected by the data collector 220. The properties and principles performed by the EVT mechanism 218 are based on a convergence property of the tail of probability density functions captured by the 2nd fundamental theorem of extreme value statistics, the Pickands-Balkema-de Haan theorem. The EVT mechanism 218 applies the Pickands-Balkema-de Haan theorem using a peak over threshold (POT) technique to extract the threshold z, which accurately predicts thresholds associated with very small risk factors r<<1 that otherwise cannot be estimated empirically. As referenced herein, a small risk factor is an event so rare that it may never have been observed in the past.

The primary ML model 219a calculates probability value and the threshold for features in a sample set of the input data 214. For example, the primary ML model 219a selects a random number of observations, or features, of the input data 214 identified as S={s_1, s_2, . . . , s_n}. The random number of observations are defined a n_init for each feature as a calibration set C. Given the risk factor q, which may be defined by a user, the EVT mechanism 218 extracts the threshold z such that the probability of any sample s in the input data 214 to exceed the threshold z is less than the desired risk factor q. In other words Prob(s<=z)<=q. The threshold z is extracted by fitting the tail of the calibration set C to a Generalized Pareto Distribution (GPD) parametrized by two parameters sigma σ and gamma γ. The sigma σ and gamma γ parameters are learned from the calibration dataset C. Upon the sigma σ and gamma γ parameters being learned, an invertible non-linear relationship is identified between the threshold z and the risk factor q. Thus, instead of using a known risk factor and inferring a threshold, the primary ML model 219a instead uses the extracted threshold value z to calculate the risk factor q for each feature in the calibration set C.

Therefore, for every feature in the calibration set C, all remaining samples S={s_1, . . . , s_n} are used as threshold values z which are used to determine the relevant risk factor q. For example, for a sample s_i that has feature values (f_1, f_2, f_3, . . . , f_k), the primary ML model 219a calculates a series of threshold values, namely (z_i_1, z_i_2, . . . , z_i_k), for each feature in the sample s_i. Because the risk factor q can be interpreted as real mathematical probability, the value of each risk factor q is used as an outlier score, such that the probability associated with feature j of sample s_i as extracted by the EVT mechanism 218. This relationship is shown by Equation 1, which states the outlier score associated with feature j of sample s_i is equal to log(1/q_i_j).

a_i_j=log(1/q_i_j) Equation 1

An overall score for the sample i is provided as the sum of each outlier score a_i_j for all j features.

The primary ML model 219a performs these operations to learn the sigma σ and gamma γ parameters and calculate the risk factor q using an equation that measures a final threshold z_{q} as approximately equal to the desired probability, or desired risk factor, q multiplied by the total number of observations n over the number of peaks Nₜ in the dataset, all raised to the power of negative gamma γ, minus one, multiplied by a proportion of parameters sigma σ and gamma γ, plus the initial threshold t. This equation is provided as Equation 2 below.

$${z}_{q} ≃ t + \frac{σ}{γ} ( {( \frac{qn}{{N}_{t}} )}^{- γ} - 1 ) \qquad Equation 2$$

Ultimately, the risk factor q is extracted for each data point, or feature, in the input data 214. The score generator 222 compares the risk factor q to the extracted threshold and generates an outlier score that that is assigned as log(1/q) and measures the risk factor q relative to the threshold. In other words, the outlier score is a measure that quantifies a degree to which the risk factor q is an outlier from the dataset.

In some examples, the risk thresholds {r_1, r_2, . . . , r_n} are calibrated for each engineering system that implements the system 200. The primary ML model 219a uses the selects an initial set of risk factors, identified as {r_1_init, r_2_init, . . . , r_n_init}. In some examples, the risk factors are domain-specific and are determined according to the understanding of the domain, and then optimized as described herein to optimize the intelligent threshold for the data. For example, for a virtual storage system, the risk factors include latency, throughput, and bandwidth. In some examples, an existing system has thresholds to be determined for data for each of the risk factors. In some examples, the risk factors are the output of several models built on these risk factors. Each risk factor r_n_init is an example of the risk factor q calculated as described herein. In some examples, each risk factor r_n_init is a risk factor for a different data source. For example, r_1_init is the risk factor for a first data source, r_2 init is the risk factor for a second data source, and r_n_init is the risk factor for an nth data source. As referenced herein, the data source may be an IoT device 234, a virtual computing machine 236, a data lake 238, and so forth.

The primary ML model 219a uses the selected initial set of risk factors r_1_init, r_2_init, . . . , r_n_init} to determine a set of value thresholds {z_1, z_2, . . . z_n) associated with the respective risk factors as described herein. For example, z_1 is the value threshold associated with the risk factor r_1_init, z_2 is the value threshold associated with the risk factor r_2_init, z_n is the value threshold associated with the risk factor r_n_init, and so forth.

The score generator 222 is implemented on the processor 208 as an element of the anomaly detector 216 and generates an outlier score for the sample, assigned as log(1/q). The anomaly identifier 224 is implemented on the processor 208 as an element of the anomaly detector 216 and compares the generated outlier score to the determined set of value thresholds {z_1, z_2, . . . z_n) to determine whether to classify the sample for which the outlier score is generated as an anomaly or not an anomaly. Based on the comparison to the threshold, the anomaly identifier 224 predicts whether the sample is an anomaly or not as anomaly. For example, an outlier score above the value threshold indicates a potential anomaly and the anomaly identifier 224 predicts the sample is an anomaly, while an outlier score below the value threshold indicates the sample is likely not an anomaly and the anomaly identifier 224 predicts the sample is not anomaly.

The anomaly identifier 224 sends the samples identified as potential anomalies to the investigator 226. In some examples, the investigator 226 is a specialized processing unit implemented on the processor 208 that investigates the identified potential anomalies to either confirm the identified potential anomaly is an anomaly or reject the potential anomaly as not an anomaly and a false positive.

The investigator 226 returns a schema 227 that includes all thresholds and a label that indicates the potential anomaly is either an anomaly or not an anomaly. In some examples, the labels are binary. For example, a label equal to 1 indicates the sample is an anomaly, while a label equal to 0 indicates the sample is not an anomaly. The schema 227 is defined as {r_1_t, r_2_t, . . . r_n_t; [label]}. For example, a schema 227 for a sample that is confirmed as an anomaly is {r_1_t, r_2_t, . . . r_n_t; 1}, while a schema 227 for a sample that is determined not to be an anomaly is {r_1_t, r_2_t . . . r_n_t; 0}. The schema 227 is sent to the primary ML model 219a as feedback for the ML model of the anomaly detector 216.

The primary ML model 219a receives the schema 227 as feedback regarding the outlier score and/or potential anomaly in the sample. In some examples, receiving the schema 227 as feedback triggers an action by the primary ML model 219a. For example, where the schema 227 is labeled with a 1 to indicate the sample was correctly identified as an anomaly, the schema 227 provides positive feedback to reinforce the threshold that was determined for the risk factors, and no additional adjustment is performed. In examples where the schema 227 is labeled with a 0 to indicate the sample is not an anomaly and was therefore given a score by the score generator 222 that led to the incorrect identification as an anomaly by the anomaly identifier 224, the primary ML model 219a adjusts the risk factors in order to optimize and redetermine the set of value thresholds {z_1, z_2, . . . z_n) associated with the respective risk factors.

In some examples, risk factors are adjusted based on an analysis performed based on a comparison of a test value to a value from a uniform distribution. By utilizing the adjustment mode, the primary ML model 219a realizes the benefits of the determined threshold while adjusting the threshold based on real data. In some examples, the value of the adjustment mode is a ratio, such as fifty percent. The value of the adjustment mode is a frequency at which, i.e., a percentage of iterations in which, the primary ML model 219a uses the existing threshold. In examples where the value of the adjustment mode is fifty percent, the primary ML model 219a uses the existing threshold in fifty percent of the iterations and in the remaining iterations, alters the threshold by a small amount. This resulting data is recorded, stored, and is used as an input to further optimize the threshold in a next iteration of the primary ML model 219a. For example, where the schema is labeled with a 0 to indicate the potential anomaly was in fact not anomalous, further optimization of the threshold is possible and the primary ML model 219a uses the feedback as an opportunity to diversify the dataset. This is done by increasing the thresholds by five percent with a probability of fifty percent, meaning fifty percent of the time the threshold is maintained and the remaining time the primary ML models 219a explores and updates the threshold.

Thus, the primary ML model 219a uses the analysis to determine whether to raise or lower the threshold, and if so, by what degree. The threshold for a system i is z_i. In some examples, the primary ML model 219a activates an adjustment mode and selects a test value from a uniform distribution. Where the uniform distribution value is set to equal 0.5, the test value is selected and if the test value is greater than the uniform distribution value, i.e., 0.5, the primary ML model 219a determines to explore, while where the test value is not greater than the uniform distribution value, the primary ML model 219a determines to exploit. The threshold is then adjusted, i.e., increased or decreased, by a percentage according to the uniform distribution value. For example, where the uniform distribution value is 0.5, the threshold is increased by 5.0% or decreased by 5.0%. In approximately half of the analyses, i.e., based on the adjustment mode value of 50.0%, the threshold is increased and in approximately half of the analyses, the threshold is not increased and the threshold initially determined by the EVT mechanism 218 is used. By alternatively increasing and maintaining the threshold, each iteration of the primary ML model 219a for the sample is varied, providing more robust training for the ML aspects of the EVT mechanism 218.

In some examples, using the threshold output by the primary ML model 219a is referred to an exploit mode, as the primary ML model 219a leverages the output of the primary ML model 219a as-is. In some examples, changing the threshold in real-time, rather than using the threshold output as is, is referred to as an explore mode, where the threshold is adjusted upwards by a factor. The results of each iteration of the primary ML model 219a are tabulated and form input to another iteration of the primary ML model 219a to further refine the thresholds. In some examples, this is referred to as a last mile optimization of the thresholds.

It should be understood that while outlier scores generated by the score generator 222 that are above the threshold are flagged as potential anomalies by the anomaly identifier 224 and sent to the investigator 226 for analysis, generated outlier scores of samples that are below the threshold are not flagged as potential anomalies and not sent to the investigator 226. However, a second type of anomaly, in addition to the risk factors that have an outlier score above the threshold, are samples that have generated scores below the threshold but in fact are a valid anomaly that was not detected by the generation of the outlier score. In other words, these anomalies are false negatives. False negatives may lead to outages, failures, fraud, and so forth. Upon eventual detection of the false negative, the false negative is sent to the investigator 226. The investigator 226 generates the schema 227 with a label equal to 1, to indicate an anomaly, and returned to the primary ML model 219a as described herein and used as feedback for a next iteration of the ML model 219.

The incidents that occurred as a result of the false negative is stored in an incident database 225 as a record of the false negative and the incident. The record includes the sample details, observation details, the threshold used, details regarding the event, the timestamp, and the real-world label for the observation. In some examples, the real-world label is the label assigned as a result of the review of the incident by the investigator 226. This provides the primary ML model 219 with real-world data regarding whether the prediction deemed as an anomaly was a true anomaly or not in the real-world. In some examples, the calibration sample C, i.e., n_init, used to calibrate the threshold is enriched with the record or records stored in the incident database 225.

Upon a sufficient number of iterations of samples having been collected, primary ML model 219a is trained to extract optimal values of risk factors {r_1_opt, r_2_opt, . . . , r_n_opt} that maximize an F1-score for the primary ML model 219a. In some examples, the sufficient number of samples is a predetermined threshold number of samples. For example, the sufficient number of samples may be 500 samples, 1000 samples, 1500 samples, and so forth that are determined enough to determine thresholds for a particular type of data. As referenced herein, an F1 score is a metric that measures precision and recall of a particular dataset. Recall is a measure of how many events are returned, while precision measures, out of the returned events, how many are valid anomalies. Where the return is high, i.e., more samples are returned, the precision is lower and where the return is low, i.e., fewer samples are returned, the precision is higher. In some examples, the primary ML model 219a maintains a history of structured records as tuples {r_1_t, r_2_t, . . . r_n_t; label} based on the tagging done by the investigator 226. In some examples, the EVT mechanism 218 builds a secondary ML model 219b based off these tuples to adjust the thresholds. In some examples, the secondary ML model 219b is trained based on the feedback schema and the threshold or thresholds optimized by the primary ML model 219a.

In some examples, a confirmed anomalous sample triggers a task, or action, to be executed. Triggered tasks are executed by the task executor 232. The task executor 232 is implemented on the processor 208 and executes the triggered task based on the outlier score being above the threshold level. In examples where the system 200 is an engineering system for one or more IoT devices 234 that detects an anomaly in an IoT device 234, the outlier score may indicate that a particular device has failed or is susceptible to failing and the triggered action is to initiate repair or replacement of the IoT device 234. In examples where the system 200 is a virtual computing machine 236 for a payment system, the outlier score may indicate an order of an unusual size or from an unusual account and the triggered action is to flag the order as potentially fraudulent and either decline to process the order or investigate the order prior to fulfillment.

The user interface 230 may be presented on a display, such as a display 228, of the system 200. The user interface 230 may present status updates including data points identified as outliers, all data points, calculated thresholds, triggered actions to be taken, triggered actions that have been taken, and so forth.

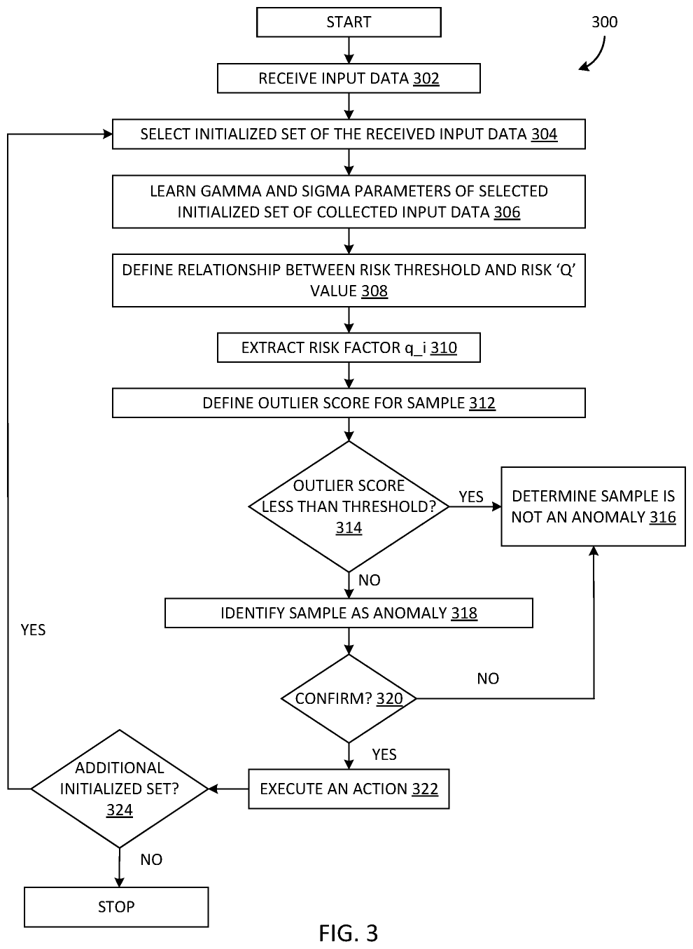

FIG. 3 is a flowchart illustrating a computer-implemented method of determining whether a sample is anomalous according to various examples of the present disclosure. The operations illustrated in FIG. 3 are for illustration and should not be construed as limiting. Various examples of the operations may be used without departing from the scope of the present disclosure. The operations of the method 300 illustrated in the flow chart of FIG. 3 may be executed by one or more components of the system 200, including the processor 208, the anomaly detector 216 including the EVT mechanism 218 and the data collector 220, the investigator 226, and the task executor 232.

The method 300 begins by the data collector 220 receiving, or collecting, input data in operation 302. In some examples, the received input data 214 is defined as S={s_1, s_2, . . . , s_n}. The input data may be data collected from one or more sources and stored in the data storage device 212 as the input data 214 described herein. In some examples, the data collector 220 collects data from one or more IoT devices 234. In some examples, the data collector 220 collects data from one or more virtual computing machines 236 that may perform services including, but not limited to, cloud computing, video or audio streaming, virtual storage, and so forth. In some examples, the input data 214 is received in real-time from the one or more sources. For example, where the data collector 220 collects data related to video or audio streaming, the input data 214 is streaming data received in real-time. In another example, where the data collector 220 collects data from one or more IoT devices 234, the input data 214 is data captured by one or more sensors of the one or more IoT devices 234 in real time.

In operation 304, the EVT mechanism 218 selects an initialized set of the received input data 214 to be used as a calibration set C of the input data 214. In some examples, the initialized set of the received input data 214 is a subset of the received data. Each feature of the input data 214 comprises a number of features, k. which is expressed as s_i={f_1, f_2, . . . , f_k}. The initialized set of the received input data 214 is defined a n_init, as described herein. The EVT mechanism 218 may select the initialized set of the received input data 214 based on various factors. In some examples, the initialized set of the received input data 214 is selected randomly. In some examples, the initialized set of the received input data 214 is selected based on the most recent data points received. In some examples, the initialized dataset is updated on an ad-hoc basis with new samples that have been confirmed as anomalies, such as by the investigator 226.

In operation 306, the EVT mechanism 218 learns the sigma σ and gamma γ parameters of the selected initialized set of collected input data 214 using Equation 2. In some examples, the sigma σ and gamma γ parameters are learned using a method of moments technique, a probability weighted moments technique, by optimizing a Generalized Pareto Distribution (GPD) on the calibration set C, or any other suitable methods.

In operation 308, the EVT mechanism 218 defines the relationship between the threshold and the risk factor q based on the learned sigma σ and gamma γ parameters based on Equation 2. In operation 310, the EVT mechanism extracts the risk factor q_i for each feature is the selected initialized set of the received input data 214 based on the defined relationship between the threshold and the risk factor q. For example, once the sigma σ and gamma γ parameters are learned, each of the other values, including the sample value z, are inserted into Equation 2 to solve for the risk factor q. In some examples, the EVT mechanism extracts a risk factor q_i for each feature, which is the selected initialized set of the received input data 214 based on the relationship between the threshold and the risk factor q.

In operation 312, the score generator 222 generates an outlier score for the sample, assigned as log(1/q). In operation 314, the anomaly identifier 224 compares the generated outlier score to the determined set of value thresholds {z_1, z_2, . . . z_n) to determine whether to classify the sample for which the outlier score is generated as an anomaly or not an anomaly. Where the outlier score is less than the threshold, the anomaly identifier 224 determines the sample is not an anomaly in operation 316. Where the outlier score is not less than the threshold, e.g., the outlier score is the same as or greater than the threshold, the anomaly identifier 224 identifies the sample as an anomaly in operation 318.

In operation 320, the investigator analyzes the identified anomaly to confirm whether or not the identified sample is indeed an anomaly or not. As described herein, the investigator 226 investigates the identified potential anomalies to either confirm the identified potential anomaly is an anomaly or reject the potential anomaly as not an anomaly. The investigator 226 returns the schema 227 to the primary ML model 219a that confirms the sample is an anomaly or that determines the identification of the sample of the anomaly was a false positive. Where the sample is determined to be a false positive, the schema 227 is returned to the primary ML model 219a, which proceeds to operation 316 to determine the sample is not an anomaly. Where the sample is confirmed to be an anomaly, the schema 227 is returned to the primary ML model 219a, which proceeds to operation 322 to trigger an action.

In operation 322, the task executor 232 executes an action based on the confirmation of the sample as an anomaly. As described herein, the action being performed is particular to the type of system 200 executing the operations of the method 300. In examples where the system 200 is an engineering system for one or more IoT devices 234 that detects an anomaly in an IoT device 234, the outlier score may indicate that a particular device has failed or is susceptible to failing and the triggered action is to initiate repair or replacement of the IoT device 234. In examples where the system 200 is a virtual computing machine 236 for a payment system, the outlier score may indicate an order of an unusual size or from an unusual account and the triggered action is to flag the order as potentially fraudulent and either decline to process the order or investigate the order prior to fulfillment. In examples where the system 200 is a virtual storage system, the outlier score may indicate data being stored in an unusual location and the triggered action is to flag the stored data as potentially fraudulent.

In operation 324, the primary ML model 219a determines whether an additional initialized data set has been received by the data collector 220 and/or whether additional features from the initially received data are to be defined. For example, where the received input data 214 is video or audio streaming data, new data is constantly provided in real time. Where additional initialized data sets are available, the method 300 returns to operation 304 and selects another initialized set of the received input data 214. The method 300 then proceeds through operations 304-324 until, in operation 324, no additional initialized data sets are found, and the method 300 terminates.

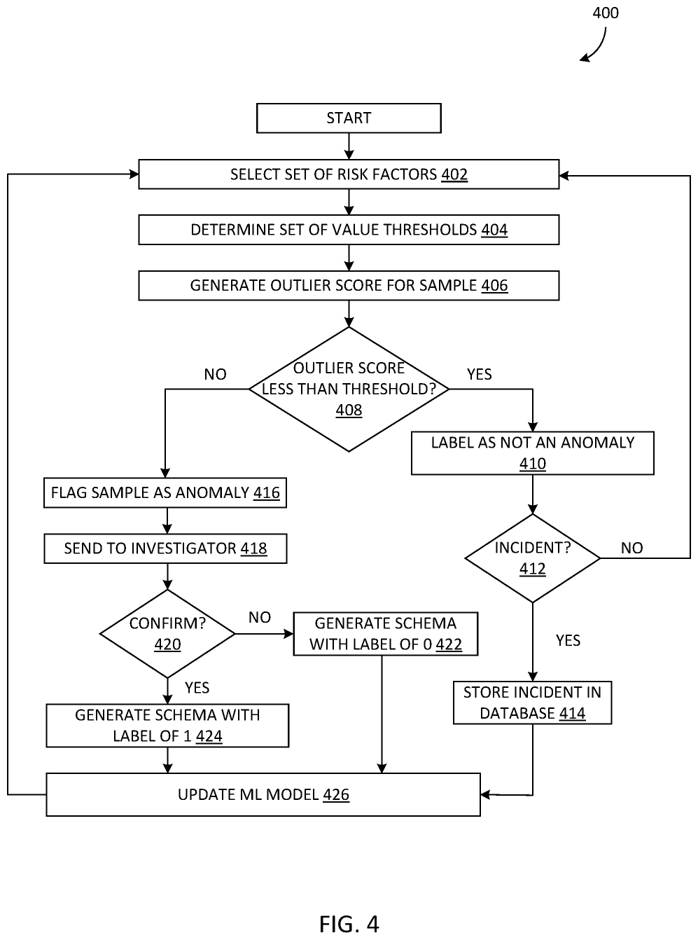

FIG. 4 is a flowchart illustrating a computer-implemented method of optimizing an intelligent threshold in a ML model according to various examples of the present disclosure. The operations illustrated in FIG. 4 are for illustration and should not be construed as limiting. Various examples of the operations may be used without departing from the scope of the present disclosure. The operations of the method 400 illustrated in the flow chart of FIG. 4 may be executed by one or more components of the system 200, including the processor 208, the anomaly detector 216 including the EVT mechanism 218 and the data collector 220, the investigator 226, and the task executor 232.

The method 400 begins by the primary ML model 219a selecting a set of risk factors in operation 402. In some examples, the initial set of risk factors are identified as {r_1_init, r_2_init, . . . , r_n_init}, where each risk factor r_n_init is a risk factor for a different data source. For example, r_1_init is the risk factor for a first data source, r_2_init is the risk factor for a second data source, and r_n_init is the risk factor for an nth data source. As referenced herein, the data source may be an IoT device 234, a virtual computing machine 236, a data lake 238, and so forth.

In operation 404, the primary ML model 219a determines a set of value thresholds. In some examples, the set of value thresholds are identified as {z_1, z_2, . . . z_n) and associated with the respective risk factors as described herein. For example, z_1 is the value threshold associated with the risk factor r_1_init, z_2 is the value threshold associated with the risk factor r_2_init, z_n is the value threshold associated with the risk factor r_n_init, and so forth.

In operation 406, the score generator 222 generates an outlier score for the sample, assigned as log(1/q). In operation 408, the anomaly identifier 224 compares the outlier score to the determined threshold, i.e., the anomaly identifier 224 determines whether the outlier score is less than the set of value thresholds. Where the outlier score is less than the threshold, the anomaly identifier 224 labels the sample as not an anomaly in operation 410. The primary ML model 219a continues to monitor transmissions from the investigator 226 that indicate the label was a false negative. For example, in operation 412, the primary ML model 219a determines whether an incident has been reported for the sample labeled as not an anomaly. An incident includes, but is not limited to, an outage, a failure, fraud, and so forth of the data source represented by the risk factor or risk factors in the sample. Where an incident is not detected, the method 400 returns to operation 402 and selects a set of risk factors for a next iteration of the method 400. Where an incident is detected, the EVT mechanism 218 stores a record of the incident in the incident database 225 in operation 414. The record includes the sample details, observation details, the threshold used, details regarding the event, the timestamp, and the real-world label for the observation. In some examples, the real-world label is the label assigned as a result of the review of the incident by the investigator 226. The primary ML model 219a then updates in operation 426 as described in greater detail below.

Where the outlier score is not less than the threshold in operation 408, e.g., the outlier score is greater than or equal to the threshold, the anomaly identifier 224 flags the sample as an anomaly in operation 416. In operation 418, the EVT mechanism 218 sends the flagged sample to the investigator 226 to investigate the sample. In operation 420, the investigator 226 investigates the identified potential anomalies to either confirm the identified potential anomaly is an anomaly or reject the potential anomaly as not an anomaly and a false positive.

In operation 422, the investigator 226 generates the schema 227 with a label of 0, for example, {r_1_t, r_2_t, . . . r_n_t; 0}, to indicate the sample is not an anomaly and a false positive based on the investigator 226 determining the sample is not an anomaly and therefore was mischaracterized by the anomaly identifier 224. The schema 227 is sent to the primary ML model 219a as feedback for the ML model of the anomaly detector 216. In contrast, in operation 424, the investigator 226 generates the schema 227 with a label of 1, for example, {r_1_t, r_2_t, . . . r_n_t; 1}, to confirm the sample is an anomaly and was correctly characterized by the anomaly identifier 224. The schema 227 is sent to the primary ML model 219a as feedback for the ML model of the anomaly detector 216.

In operation 426, the primary ML model 219a updates. In some examples, the primary ML model 219a updates continuously based on receiving one or more of a notification of a new incident stored in the incident database 225, a schema 227 with a label of 0 following operation 422, or a schema 227 with a label of 1 following operation 424. In some examples, the primary ML model 219a updates by adjusting the risk factors in order to optimize and redetermine the set of value thresholds {z_1, z_2, . . . z_n) associated with the respective risk factors. In some examples, the risk factors are adjusted based on an analysis performed based on a comparison of an adjustment mode to a value from a uniform distribution. Following the update to the primary ML model 219a, the method 400 returns to operation 402 and selects a new set of risk factors for a next iteration of the method 400.

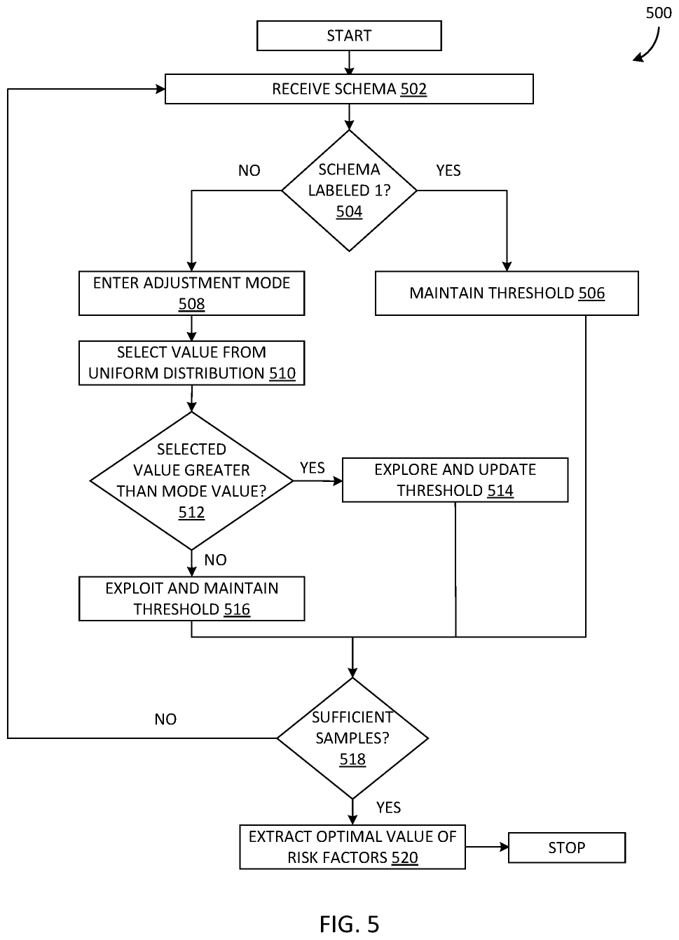

FIG. 5 is a flowchart illustrating a computer-implemented method of optimizing an intelligent threshold in a ML model according to various examples of the present disclosure. The operations illustrated in FIG. 5 are for illustration and should not be construed as limiting. Various examples of the operations may be used without departing from the scope of the present disclosure. The operations of the method 500 illustrated in the flow chart of FIG. 5 may be executed by one or more components of the system 200, including the processor 208, and the anomaly detector 216 including the EVT mechanism 218 and the data collector 220.

The method 500 begins by the primary ML model 219a receiving the schema 227 from the investigator 226. As described herein, the schema 227 is defined as {r_1_t, r_2_t, . . . r_n_t; [label]} and includes all thresholds with a label that indicates the potential anomaly is either an anomaly or not an anomaly. In operation 504, the primary ML model 219a determines whether the schema 227 is labeled as 1, indicating the sample has been confirmed to be an anomaly. Where the schema 227 is labeled as 1, indicating the sample is an anomaly, the primary ML model 219a maintains the threshold in operation 506. In some examples, maintaining the threshold refers to the primary ML model 219a determining not to update the threshold. Because the feedback received from the investigator 226 indicates the threshold properly identified the anomaly, the primary ML model 219a is not incentivized to update, or adjust, any of the factors contributing to the threshold.

Where the schema 227 is not labeled as 1, i.e., is labeled as 0 indicating the sample is not an anomaly, the primary ML model 219a enters an adjustment mode in operation 508. In some examples, the adjustment mode is referred to as an explore/exploit mode and is the mechanism by which the primary ML model 219a determines to either raise or lower the threshold for detecting an anomaly and if so, by what degree. In some examples, the adjustment mode has a default adjustment mode value that indicates the degree by which the threshold is to be updated. For example, the adjustment mode value may be 0.1, 0.2, 0.5, 1.0, or any other suitable value. In other examples, the adjustment mode value is selected by the primary ML model 219a.

In operation 510, the primary ML model 219a selects a value from a uniform distribution. The value from the uniform distribution is a predetermined value that determines the percentage of the time the threshold is used as is, i.e., in an exploit mode, or changed, i.e., in an explore mode. The selected value may be 0.1, 0.2, 0.5, 1.0, or any other suitable value. In operation 512, the selected value is compared to the adjustment mode value.

In examples where the selected value is greater than the adjustment mode value, the primary ML model 219a proceeds to operation 514 and enters an explore mode. In explore mode, the primary ML model 219a updates the values of the risk factors {r_1, r 2, . . . , r_n} upon which the threshold is based. In various examples, the risk factors may be latency, throughput, bandwidth for a virtual storage system, and so forth for a virtual storage system; such as package dropouts, errors, flagged security incidents in a virtual networking system, and so forth. In examples where the selected value is not greater than the adjustment mode value, the primary ML model 219a proceeds to operation 516 and enters an exploit mode. In exploit mode, the primary ML model 219a maintains the risk factors {r_1, r 2, . . . , r_n} upon which the threshold is based.

Following each of operations 506, 514, and 516, the method 500 proceeds to operation 518 and the primary ML model 219a determines whether a sufficient number of samples have been provided to train the primary ML model 219a. As described herein, the sufficient number of samples is a predetermined threshold number of samples. For example, the sufficient number of samples may be 500 samples, 1000 samples, 1500 samples, and so forth that are determined enough to determine thresholds for a particular type of data.

Where a sufficient number of samples have not been obtained, the method 500 returns to operation 502 and waits for a new or updated schema 227 to be received from the investigator 226. Where a sufficient number of samples are determined to have been obtained, in operation 520 the primary ML model 219a extracts optimal values of risk factors {r_1_opt, r_2_opt, . . . , r_n_opt} that maximize an F1-score for the primary ML model 219a. The optimal risk factors are a set of risk factors that return an F1 score with the greatest precision while minimizing the return to the extent possible. Following operation 520, the method 500 terminates.

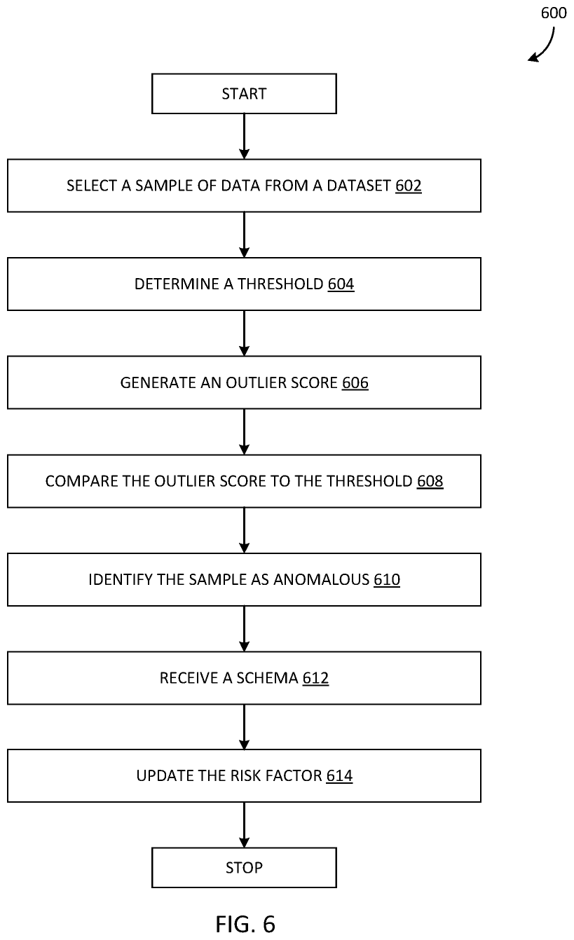

FIG. 6 is a flowchart illustrating a computer-implemented method of updating a ML model according to various examples of the present disclosure. The operations illustrated in FIG. 6 are for illustration and should not be construed as limiting. Various examples of the operations may be used without departing from the scope of the present disclosure. The operations of the method 600 illustrated in the flow chart of FIG. 6 may be executed by one or more components of the system 200, including the processor 208, and the anomaly detector 216 including the EVT mechanism 218 and the data collector 220.

The method 600 begins by the primary ML model 219a selecting a sample of data from a dataset in operation 602. In some examples, the selected sample of data is an initial set of risk factors, identified as {r_1_init, r_2_init, . . . , r_n_init}. Each risk factor r_n_init is an example of the risk factor q calculated as described herein. In some examples, each risk factor r_n_init is a risk factor for a different data source.

In operation 604, the primary ML model 219a uses the selected initial set of risk factors r_1_init, r_2_init, . . . , r_n_init} to determine a set of value thresholds {z_1, z_2, . . . z_n) associated with the respective risk factors as described herein. For example, z_1 is the value threshold associated with the risk factor r_1_init, z_2 is the value threshold associated with the risk factor r_2_init, z_n is the value threshold associated with the risk factor r_n_init, and so forth.

In operation 606, the score generator 222 generates an outlier score for the sample, assigned as log(1/q). In operation 608, the anomaly identifier 224 compares the generated outlier score to the determined threshold to determine whether to classify the sample for which the outlier score is generated as an anomaly or not an anomaly. In operation 610, the anomaly identifier 224 identifies the sample as anomalous based on the generated outlier score being greater than the threshold. The identification of the sample as an anomaly is sent to the investigator 226 for investigation into the identified anomalous sample.

In operation 612, the primary ML model 219a receives the schema 227 from the investigator 226. The schema 227 includes an identification of the risk factor and a binary label. For example, the schema 227 is presented as {r_1_t, r_2_t, . . . r_n_t; [label]}, where r_n_t is an identification of the particular risk factor and the [label] is a binary label of either a first label or a second label. The first label, 1, confirms the sample is anomalous, while the second label, 0, identifies the sample as not anomalous. For example, a schema 227 for a sample that is confirmed as an anomaly is {r_1_t, r_2_t, . . . r_n_t; 1}, while a schema 227 for a sample that is determined not to be an anomaly is {r_1_t, r_2_t, . . . r_n_t; 0}.

In operation 614, based on the schema 227 including the first label to identify that the sample identified as anomalous is in fact not an anomaly, the primary ML model 219a updates the risk factor. In some examples, updating the risk factor includes comparing a selected test value to a uniform distribution value, determining the selected test value is greater than the uniform distribution value, and adjusting the risk factor by a percentage according to an adjustment mode value and the uniform distribution value. In some examples, the adjustment mode value is a predefined value identifying a frequency at which the risk factor is adjusted. In some examples, the uniform distribution value is a value identifying a degree to which the risk factor is adjusted.

In some examples, the method 600 further includes executing an action based on receiving the schema 227 including the second label.

In some examples, the method 600 further includes after receiving the schema including the second label, receiving a notification of an incident involving the sample, and storing a record of the incident in the incident database 225.

In some examples, the method 600 further includes identifying an optimal value for the risk factor based on the updated threshold, and extracting the optimal value for the risk factor.

### Additional Examples

Some examples herein are directed to a method that uses extreme value theory (EVT) to optimize intelligent thresholds and threshold engines in machine learning operations (MLOps) systems. The method (600) includes selecting (602), by a machine learning (ML) model (219a) of an extreme value theory (EVT) mechanism (218), a sample of data from a dataset, the sample including a risk factor; determining (604), by the ML model, a threshold for the sample based at least in part on the risk factor, generating (606), by a score generator (222), an outlier score for the sample, comparing (608), by an anomaly identifier (224), the generated outlier score to the determined threshold, identifying (610), by the anomaly identifier, the sample as anomalous based on the generated outlier score being greater than the threshold, receiving (612), by the ML model, a schema (227) comprising results of an investigation into the sample, and updating (614), by the ML model, the risk factor based on the received schema.

In some examples, the received schema includes an identification of the risk factor and a binary label.

In some examples, the binary label includes either a first label confirming the sample is anomalous or a second label identifying the sample as not an anomaly.

In some examples, the method further comprises updating the determined threshold based on the received schema including the first label.

In some examples, the method further comprises executing an action based on receiving the schema including the second label.

In some examples, the method further comprises after receiving the schema including the second label, receiving a notification of an incident involving the sample and storing a record of the incident in an incident database.

In some examples, updating the determined threshold further comprises selecting a test value, comparing the selected test value to a uniform distribution value, determining the selected test value is greater than the uniform distribution value, and adjusting the risk factor by a percentage according to an adjustment mode value and the uniform distribution value.

In some examples, the adjustment mode value is a predefined value identifying a frequency at which the risk factor is adjusted and the uniform distribution value is a value identifying a degree to which the risk factor is adjusted.

In some examples, the method further comprises identifying an optimal value for the risk factor based on the updated risk factor and extracting the optimal value for the risk factor.

Some examples herein are directed to a system that uses extreme value theory (EVT) to optimize intelligent thresholds and threshold engines in machine learning operations (MLOps) systems. The system (200) includes a processor (208), a memory (202) storing instructions (204) executable by the processor, a machine learning (ML) model (219a) of an extreme value theory (EVT) mechanism (218), implemented on the processor, that selects a sample of data from a dataset, the sample including a risk factor and determines a threshold for the sample based at least in part on the risk factor, a score generator (222), implemented on the processor, that generates an outlier score for the sample, and an anomaly identifier (224), implemented on the processor, that compares the generated outlier score to the determined threshold and identifies the sample as anomalous based on the generated outlier score being greater than the threshold. The ML model further receives a schema (227) comprising results of an investigation into the sample, updates the risk factor based on the received schema, and executes an action based on the received schema.

Some examples herein are directed to one or more computer-storage memory devices (202) embodied with executable instructions (204) that, when executed by a processor (208), cause the processor to select, by a machine learning (ML) model (219a) of an extreme value theory (EVT) mechanism (218), to a sample of data from a dataset, the sample including a risk factor, determine, by the ML model, a threshold for the sample based at least in part on the risk factor, generate, by a score generator (222), an outlier score for the sample, compare, by an anomaly detector (224), the generated outlier score to the determined threshold, identify, by the anomaly detector, the sample as anomalous based on the generated outlier score being greater than the threshold, receive, by the ML model, a schema (227) comprising results of an investigation into the sample, update, by the ML model, the risk factor based on the received schema, and execute, by the ML model, an action based on the received schema.

Although described in connection with an example computing device 100 and system 200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, servers, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A computer-implemented method, comprising:
selecting, by a machine learning (ML) model of an extreme value theory (EVT) mechanism, a sample of data from a dataset, the sample including a risk factor;
determining, by the ML model, a threshold for the sample based at least in part on the risk factor;
generating, by a score generator, an outlier score for the sample;
comparing, by an anomaly identifier, the generated outlier score to the determined threshold;
identifying, by the anomaly identifier, the sample as anomalous based on the generated outlier score being greater than the threshold;
receiving, by the ML model, a schema comprising results of an investigation into the sample; and
updating, by the ML model, the risk factor based on the received schema.

2. The computer-implemented method of claim 1, wherein the received schema includes an identification of the risk factor and a binary label.

3. The computer-implemented method of claim 2, wherein the binary label includes either a first label confirming the sample is anomalous or a second label identifying the sample as not an anomaly.

4. The computer-implemented method of claim 3, further comprising:
updating the determined threshold based on the received schema including the first label.

5. The computer-implemented method of claim 3, further comprising:
executing an action based on receiving the schema including the second label.

6. The computer-implemented method of claim 3, further comprising:
after receiving the schema including the second label, receiving a notification of an incident involving the sample; and
storing a record of the incident in an incident database.

7. The computer-implemented method of claim 1, wherein updating the determined threshold further comprises:
selecting a test value;
comparing the selected test value to a uniform distribution value;
determining the selected test value is greater than the uniform distribution value; and
adjusting the risk factor by a percentage according to an adjustment mode value and the uniform distribution value.

8. The computer-implemented method of claim 7, wherein:
the adjustment mode value is a predefined value identifying a frequency at which the risk factor is adjusted; and
the uniform distribution value is a value identifying a degree to which the risk factor is adjusted.

9. The computer-implemented method of claim 1, further comprising:
identifying an optimal value for the risk factor based on the updated risk factor; and
extracting the optimal value for the risk factor.

10. A system, comprising:
a processor;
a memory storing instructions executable by the processor;
a machine learning (ML) model of an extreme value theory (EVT) mechanism, implemented on the processor, that:
selects a sample of data from a dataset, the sample including a risk factor, and
determines a threshold for the sample based at least in part on the risk factor,
a score generator, implemented on the processor, that generates an outlier score for the sample, and
an anomaly identifier, implemented on the processor, that:
compares the generated outlier score to the determined threshold, and
identifies the sample as anomalous based on the generated outlier score being greater than the threshold,
wherein the ML model further:
receives a schema comprising results of an investigation into the sample,
updates the risk factor based on the received schema, and
executes an action based on the received schema.

11. The system of claim 10, wherein the received schema includes an identification of the risk factor and a binary label.

12. The system of claim 11, wherein the binary label includes either a first label confirming the sample is anomalous or a second label identifying the sample as not an anomaly.

13. The system of claim 12, wherein the ML model further:
updates the determined threshold based on the received schema including the first label.

14. The system of claim 12, wherein the ML model further:
receives a notification of an incident involving the sample; and
stores a record of the incident in an incident database.

15. The system of claim 10, wherein, to update the determined threshold, the ML model further:
selects a test value;
compares the selected test value to a uniform distribution value;
determines the selected test value is greater than the uniform distribution value; and
adjusts the risk factor by a percentage according to an adjustment mode value and the uniform distribution value.

16. The system of claim 10, wherein the ML model further:
identifies an optimal value for the risk factor based on the updated risk factor; and
extracts the optimal value for the risk factor.

17. One or more computer-storage memory devices embodied with executable instructions that, when executed by a processor, cause the processor to:
select, by a machine learning (ML) model of an extreme value theory (EVT) mechanism, to a sample of data from a dataset, the sample including a risk factor,
determine, by the ML model, a threshold for the sample based at least in part on the risk factor,
generate, by a score generator, an outlier score for the sample,
compare, by an anomaly detector, the generated outlier score to the determined threshold,
identify, by the anomaly detector, the sample as anomalous based on the generated outlier score being greater than the threshold,
receive, by the ML model, a schema comprising results of an investigation into the sample,
update, by the ML model, the risk factor based on the received schema, and
execute, by the ML model, an action based on the received schema.

18. The one or more computer-storage memory devices of claim 17, wherein:
the received schema includes an identification of the risk factor and a binary label,
the binary label includes either a first label confirming the sample is anomalous or a second label identifying the sample as not an anomaly, and
updates the determined threshold based on the received schema including the first label.

19. The one or more computer-storage memory devices of claim 17, further embodied with instructions to update the determined threshold that, when executed by the processor, cause the processor to:
select a test value;
compare the selected test value to a uniform distribution value;
determine the selected test value is greater than the uniform distribution value; and
adjust the risk factor by a percentage according to an adjustment mode value and the uniform distribution value.

20. The one or more computer-storage memory devices of claim 17, further embodied with instructions to update the determined threshold that, when executed by the processor, cause the processor to:
identify an optimal value for the risk factor based on the updated threshold; and
extract the optimal value for the risk factor.
